(19) United States
(12) Patent Application Publication
(10) Pub. No.: US 2005/0038955 A1
(43) Pub. Date: Feb. 17, 2005

(54) Flash ROM content updating method and system

(76) Inventor: Chih-Wei Chen, I-Lan Hsian (TW)

Correspondence Address: BIRCH STEWART KOLASCH & BIRCH, PO BOX 747, FALLS CHURCH, VA, 22040-0747, US

(21) Appl. No.: 10/674,355

(22) Filed: Oct. 1, 2003

(30) Foreign Application Priority Data
Apr. 3, 2003 (TW) 092107582

(51) Int. Cl. G06F 12/16

(52) U.S. Cl. 711/103; 714/6; 717/168

(57) ABSTRACT

A flash ROM content updating method and system is disclosed, wherein the flash ROM has a plurality of memory blocks stored with primary core information. Check-sum calculation is performed on the primary core information to form and designate a check code to each memory block. Updated information is inputted and divided into a plurality of update information blocks corresponding in size to the memory blocks. The check-sum calculation is also performed on the updated information is performed to form and designate a check code to each update information block. When the check code of a memory block is not consistent with that of a corresponding update information block, the primary core information stored in the memory block is updated with the updated information in the corresponding update information block.

### BACKGROUND OF THE INVENTION

1. Field of the Invention

The invention relates to a flash ROM content updating method and a system implementing the same, and, more particularly, to a flash ROM content updating system using newly developed software to improve updating method.

2. Description of the Related Art

As new technologies rapidly progress, various types of digital devices and related components are developed with high integrity and performance. In addition to the desired lightweight and small size characteristics in hardware, multi-functional and user-friendly software device drivers and applications are also important for users to conveniently update devices themselves and solve hidden problems inside the devices such as bugs.

With the application of information appliance (IA) products, it becomes increasingly demanding for memory types to improve and develop with more satisfying characteristics such as low power consumption, low cost that can adapt to and meet different requirements. As a result, various memories such as ferroelectric RAM (FeRAM), magnetoresistive random access memory (MRAM) and ovonics unified memory (OUM) are currently available for specific market demands.

Back in 1981 when the PC was introduced, it was thought that 640K of the memory was sufficient to meet the requirement for PC memory at that time. However, it is obviously not sufficient for modern PDA devices, MP3 players, mobile phones and other devices. It is predicted that a flash memory of over 100 MB will be required for a mobile phone in the year of 2004. Beyond that, it is difficult to imagine how fast the capacity of a flash memory will grow in the future.

Presently, a digital product typically needs different types of memories including DRAM, SRAM, and flash, depending on the tasks required from the memory. For example, flash memory is usually used to store BIOS settings. The SRAM and DRAM memory types are used in large amounts due to the demands of x86 architecture and the operating system controlling it. As digital products or information appliance (IA) products incorporate multi-media, communication functions, internet access, and data bases and other memory intensive tasks, a variety of erasable PROM devices have been developed, such as UV-EPROM, EEPROM and flash ROM, so named depending on the way they update the information.

In a flash ROM, the information is accessed and written in block units. Although information processing in block units is faster than in bit or byte units, erasing and then writing whole blocks require a certain time interval. Furthermore, when there is an interruption during information updating due to an unexpected cause such as an accidental power failure, the content of the ROM may be altered with potentially serious implications.

Furthermore, the whole File, for example, BIOS instructions usually has to be written to the flash ROM, even if only a portion of the File needs updating, which results in increased processing time.

### SUMMARY OF THE INVENTION

It is therefore an objective of the invention to provide a flash ROM content updating method and a system implementing the same method in which the information stored in an electronic device such as a PDA or a PC can be quickly updated.

It is another objective of the invention to provide a flash ROM content updating method and a system implementing the same method in which information loss due to interruption of transmission during updating is reduced so as to increase the updating safety.

In the invention, check-sum of the updated information is performed after the updated information is divided into a plurality of blocks on the basis of the sizes of memory blocks of a primary information unit. The content of each update information block, including files, names, sizes, times, and dates, is given a binary check code after the check-sum processing. Then, logic operations and comparison of the check codes of the primary memory blocks and the update information blocks are performed to determine whether the check codes for the update information blocks are consistent with the check codes for corresponding memory blocks. If they are, then the primary information stored in the memory blocks is not changed, otherwise it may have been altered due to virus attacks or other factors and needs updating. If the primary information needs to be changed, then the update information is written to the memory blocks for all addresses corresponding to non-consistent check codes, that is where the check codes of the corresponding update and memory blocks are not the same.

The flash ROM content upgrading system according to the invention includes a primary information unit, an information register, and an updating device. The updating device includes a control module, a logic comparison module, an information storage module, an addressing module, an information updating module, and a check-sum module. The primary information unit includes a plurality of memory blocks each of which stores a portion of the primary information. Check-sum of the primary information is performed to compute a plurality of check codes that are respectively attached at the ends of the corresponding memory blocks. When updated information is received by the information register and the control module determines the input information needs to be decoded, check-sum of the updated information is performed, and the updated information is divided into a plurality of update information blocks each of which has the same size as the corresponding memory block and further has a check code. When the check codes of the memory blocks are compared with those of the update information blocks, the address found are stored in the addressing module when the check codes of the corresponding updated and memory blocks are not consistent (non-consistent check codes). The information updating module then performs erasing and programming of the memory blocks based on the addresses stored in the addressing module.

To provide a further understanding of the invention, the following detailed description illustrates embodiments and examples of the invention, this detailed description being provided only for illustration of the invention.

### BRIEF DESCRIPTION OF THE DRAWINGS

The present invention can be more fully understood by reading the following detailed description of the preferred embodiments, with reference made to the accompanying drawings wherein:

FIG. 1 is a block diagram of a flash ROM content upgrading system according to one embodiment of the invention;

FIG. 2 is a flow chart of flash ROM content updating according to one embodiment of the invention; and

FIG. 3A and FIG. 3B are schematic block diagrams showing the processing method for information stored in an information register and a primary information unit according to one embodiment of the invention.

### DETAILED DESCRIPTION OF THE PREFERRED EMBODIMENTS

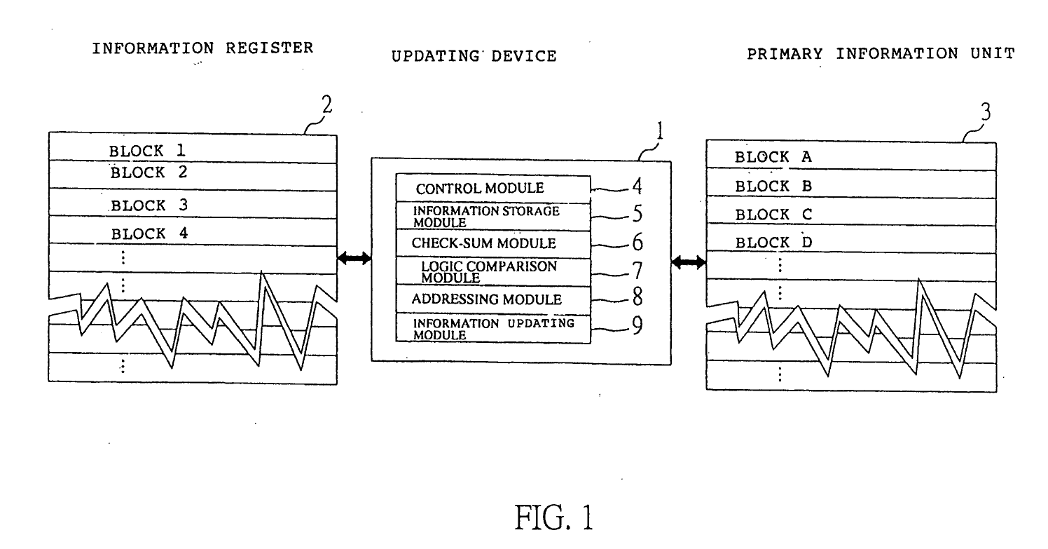

FIG. 1 is a block diagram of a flash ROM content updating system according to one embodiment of the invention. As illustrated, the system of the invention includes an updating device 1, an information register 2, and a primary information unit 3. The updating device 1 receives input data from the information register 2 and then updates the content of the primary information unit 3.

The information register 2 is, for example, a set of random access memories for temporary storage of access data and addresses contained in the device. The information register 2 stores the information to be updated received by the content updating system. The updated information then is divided into a plurality of update information blocks. In this embodiment of the invention, the information register 2 is of a RAM type such as static RAM (SRAM) or dynamic RAM (DRAM), so the content of information register is lost when the power is turned off.

The primary information unit 3 is a main memory unit of an electronic device. The primary information unit 3 includes a plurality of memory blocks each of which stores core system information such as BIOS settings, embedded software, or data files. In this embodiment of the invention, the primary information unit 3 is a flash ROM. The electronic device is, for example, a digital camera, an electronic dictionary, a personal digital assistant, a personal computer, or a laptop computer.

The updating device 1 further includes a control module 4, an information storage module 5, a check-sum module 6, a logic comparison module 7, an addressing module 8 and an information updating module 9.

The check-sum module 6 performs the division into units of blocks and calculates check-sums for both the blocks of data to be updated stored in the information register 2 and the blocks for the primary information stored in the primary information unit 3. The blocks of the data to be updated have the same size as the memory blocks of the primary information unit 3. The content of each update information block, including files, names, sizes, times, and dates, is given a binary check code after check-sum processing. Each check code is attached at the end of the program block and retained in the information register 2 for comparison performed subsequently.

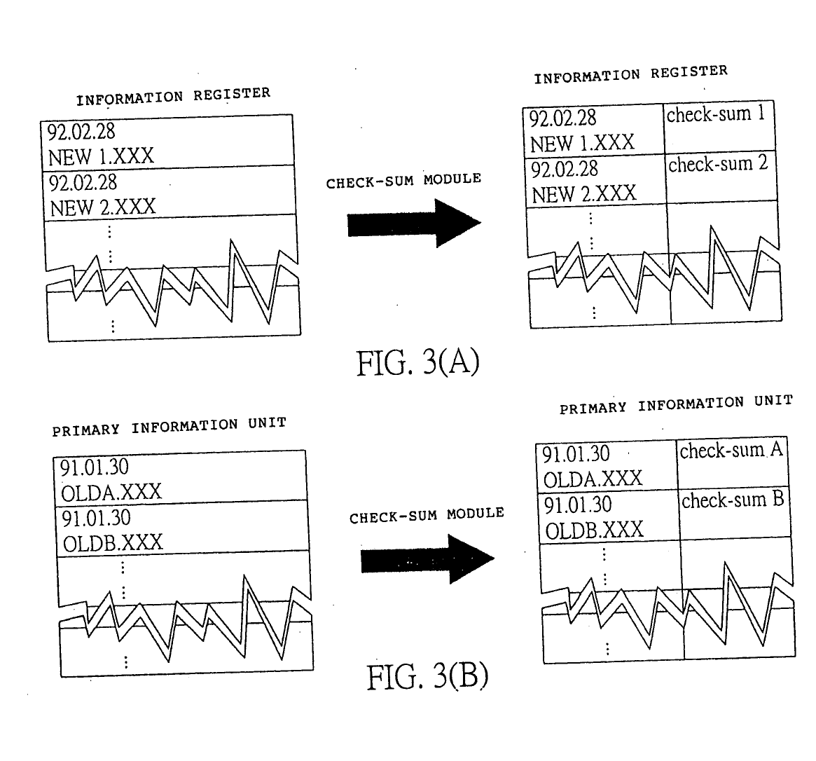

The logic comparison module 7 performs logic operations and comparison of corresponding check codes for the memory blocks in the primary information unit 3 and the information register 2 to determine whether the check codes of each update information block are consistent with the check codes of each corresponding memory block. For example, as shown in FIG. 3A and FIG. 3B, a comparison is performed to determine whether a check-sum 1 code of one block to be updated in the information register is consistent with a check-sum A code of its corresponding memory block.

The control module 4 is the operation core of the logic comparison module 7 and the other modules. In other words, the control module and the logic comparison module are the main processing modules implemented with either digital logic or a CPU running stored instructions. The control module 4 picks up an input command from the information register 2 and decodes the command to perform the related functions (in this embodiment, an update function). Then the check-sum module 6 and the logic comparison module 7 subsequently perform the division into block units, calculation of the check-sums and the encoding and logic comparison of the updated data stored in the information register 2. The addressing module 8 picks up the addresses with respect to the non-consistent check codes of the corresponding updated information in the memory blocks, as determined by the logic comparison module 7, as update addresses for updating. The addressing module 8 is a base address register or an instruction address register.

The information updating module 9 erases the preliminary information at a non-consistent update address of the memory block in the primary information unit 3. Then, the information associated with this address in the information register 2 is written to the corresponding update address in the primary information unit 3. The information updating module 9 is provided with function of ROM burner software.

The information storage module 5 has a large storage space for storage of primary programs, personal information, and the related applications and files of an electronic device.

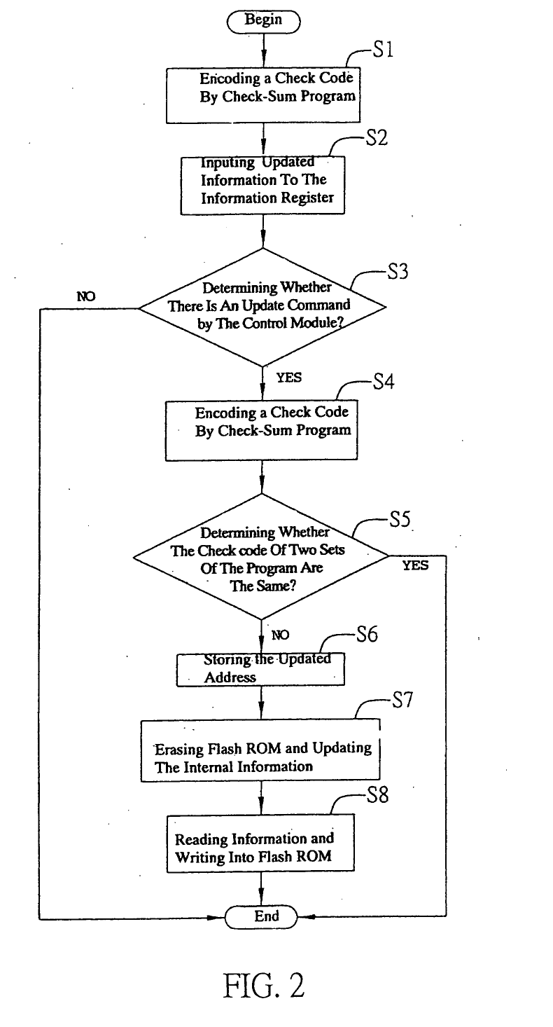

FIG. 2 is a flow chart illustrating the flash ROM content updating process according to one embodiment of the invention.

In step S1, check-sum of core information such as BIOS or embedded software and data stored in a plurality of memory blocks in the primary information unit of a flash ROM is performed to compute a plurality of check codes respectively attached at the ends of the corresponding blocks. Then, step S2 is executed.

In step S2, information is received by the information register 2. Then, step S3 is executed.

In step S3, the control module 4 determines whether there is an update command. If no, the updating then is completed. If yes, step S4 is executed.

In step S4, the check-sum module 6 performs the division into block units of the information to be updated in the information register 2 on the basis of the size of the primary blocks. Then, the check-sum and encoding of the update information blocks are performed to respectively attach the check codes at the end of the corresponding blocks. Then, step S5 is executed.

In step S5, the logic comparison module 7 performs logic operations and comparison of the check codes of the memory blocks respectively in the primary information unit 3 and the information register 2, and determines whether a check-sum 1 code of the update information block is consistent with a check-sum A sequence of the corresponding memory block. If yes, the updating then is completed. If no, step S6 is executed.

In step S6, the addressing module 8 picks up the address corresponding to the non-consistent check code of the updated and memory blocks as an update address for information updating.

In step S7, the information updating module 9 erases and then writes the content of the memory block at the update address. Then, step S8 is executed.

In the step S8, the information in the update memory block of the information register 2 is stored at the update address in the primary blocks of the primary information unit 1. Thereby, write processing of the updated information is performed. Then, the updating is completed.

FIG. 3A and FIG. 3B are schematic block diagrams illustrating the processing method for the information storage in the primary information unit 3 and the information register 2 according to one embodiment of the invention.

Referring to FIG. 3A, the information to be updated has been received by the information register 2 and undergoes division into block units that have check-sums attached by the check-sum module 6 to generate check-sum 1, check-sum 2, etc.

Referring to FIG. 3B, the core information stored in the primary information unit 3 of the electric device is processed to calculate and append check codes to the blocks by the check-sum module 6 to generate check-sum A, check-sum B, etc.

After the check-sum, encoding, and comparison of the information respectively stored in the primary information unit 3 and the information register 2, two situations are possible. Either check-sum 1 is equal to check-sum A, which means that the information in the block of check-sum A does not need updating. Or, check-sum 2 is not equal to check-sum B, which means the information in the primary information unit has changed or needs updating.

The invention has been described using exemplary preferred embodiments. However, it is to be understood that the scope of the invention is not limited to the disclosed embodiments. On the contrary, it is intended to cover various modifications and similar arrangements. For example, the device type of the flash ROM according to the invention can be, but is not limited to, a flash ROM, or any other type of information storage memory device such as UV-EPROM, EEPROM, etc. The scope of the claims, therefore, should be accorded the broadest interpretation so as to encompass all such modifications and similar arrangements.

1. A flash ROM (read-only memory) content updating system, comprising:
a primary information unit having a plurality of memory blocks for storing core operating information for the system;
an information register for storing updated information inputted to the system, wherein the updated information is divided into a plurality of update information blocks corresponding to the size of the memory blocks in the primary information unit;
a check-sum module for performing check-sum calculation to form and designate a binary check code to each of the memory blocks and the update information blocks respectively for the primary information unit and the information register;
a logic comparison module for performing logic operations and comparison on the check codes so as to determine if the check code of one of the memory blocks in the primary information unit is consistent with the check code of a corresponding one of the update information blocks in the information register;
an addressing module for storing information addresses associated with the non-consistent check codes of the corresponding memory blocks and update information blocks as determined by the logic comparison module; and
an information updating module, upon receiving the stored information addresses from the addressing module, for erasing information stored in the memory blocks having the non-consistent check codes, and for reading information from the corresponding update information blocks in the information register and writing the read information to the information-erased memory blocks.

2. The system of claim 1, wherein the primary information unit is an erasable programmable ROM (EPROM) selected from the group consisting of UV-EPROM (ultraviolet-EPROM), EEPROM (electrically EPROM), and a flash ROM.

3. The system of claim 1, wherein the core operating information includes data for BIOS (basic input/output system) settings or embedded software.

4. The system of claim 1, wherein the information stored in the information register disappears as the system is shut off, and the information register is a static random access memory (SRAM) or dynamic RAM (DRAM).

5. The system of claim 1, wherein the binary check code is obtained by performing the check-sum calculation of files, names, sizes, times, dates and content in each of the memory blocks and the update information blocks.

6. The system of claim 1, wherein the logic comparison module is located in a CPU (central processing unit).

7. The system of claim 1, wherein the addressing module is a register for storing the information addresses, which is a base address register or instruction address register.

8. The system of claim 1, wherein the information updating module is a ROM burner or burner simulation software.

9. A flash ROM content updating method for use with an information updating system so as to allow a user to quickly update information stored in a memory unit of an electronic device, the memory unit having a plurality of memory blocks stored with primary core information, the flash ROM content updating method comprising the steps of:
1) performing check-sum calculation on the primary core information stored in the plurality of memory blocks to form and designate a check code to each of the memory blocks;
2) inputting updated information via the user;
3) determining if there is an update command provided with the updated information; if no, proceeding to step 8); if yes, proceeding to step 4);
4) dividing the updated information into a plurality of update information blocks, and performing check-sum calculation for the update information blocks to form and designate a check code to each of the update information blocks;
5) determining if the check code of one of the memory blocks is consistent with the check code of a corresponding one of the update information blocks; if yes, proceeding to step 8); if no, proceeding to step 6);
6) storing information addresses associated with the non-consistent check codes of the corresponding memory blocks and update information blocks;
7) erasing the information stored in the memory blocks having the non-consistent check codes, and writing the information from the corresponding update information blocks to the information-erased memory blocks; and
8) ending the content updating process.

10. The flash ROM content updating method of claim 9, wherein the information updating system comprises:
a primary information unit having the plurality of memory blocks in step 1);
an information register for storing the updated information inputted in step 2) and performing the determination operation in step 3);
a check-sum module for performing the block division and check-sum calculation in step 4);
a logic comparison module for performing the determination operation in step 5) according to the check codes obtained in steps 1) and 4);
an addressing module for performing the address storage in step 6) according to the determination result from step 5); and
an information updating module for performing the information erasing and writing operation in step 7) according to the stored addresses from step 6).

11. The flash ROM content updating method of claim 9, wherein the electronic device is selected from the group consisting of a digital camera, electronic dictionary, personal digital assistant (PDA), personal computer (PC), and notebook computer.

12. The flash ROM content updating method of claim 9, wherein the update information blocks are sized corresponding to the memory blocks, and the updated information includes updated data for BIOS settings or embedded software.

13. The flash ROM content updating method of claim 9, wherein the check code is obtained by performing the check-sum calculation of files, names, sizes, times, dates and content in each of the memory blocks and the update information blocks.

14. The flash ROM content updating method of claim 10, wherein the addressing module is a register for storing the information addresses, which is a base address register or instruction address register.

15. The flash ROM content updating method of claim 10, wherein the information updating module is a ROM burner or burner simulation software.
